(19) United States
(12) Patent Application Publication
(10) Pub. No.: US 2006/0024601 A1
(43) Pub. Date: Feb. 2, 2006

(54) Electrophotographic toner

(75) Inventors: Satoshi Ogawa, Nara-shi (JP); Yoshiaki Akazawa, Nara-shi (JP); Masahiko Kubo, Nara-shi (JP); Hiromi Nakatsu, Amagasaki-shi (JP); Kiyoshi Toizumi, Nara-shi (JP); Masao Suzuki, Yamatokoriyama-shi (JP); Akio Matsumoto, Nara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 11/187,904

(22) Filed: Jul. 25, 2005

(30) Foreign Application Priority Data
Jul. 27, 2004 (JP) P2004-219169

(51) Int. Cl. G03G 9/097

(52) U.S. Cl. 430/108.3; 430/108.4; 430/109.1; 430/111.4; 430/109.4

(57) ABSTRACT

An electrophotographic toner is prepared by using a binder resin having an acid value of 5 to 15 mgKOH/g, a salicylic metal complex, a colorant, and a releasing agent. In the preparation determination for the third root distribution of a light emission voltage by helium atmospheric pressure microwave induction plasmas for carbon atoms derived from the binder resin and metal atoms derived from the salicylic metal complex is made based on a value measured by a micro-particle measuring apparatus including a normal pressure or atmospheric pressure space, a capillary tube inserted at one end in the space, a microwave source, a cavity, a quartz tubular reactor, a discharge means, an analyses means, and a signal detection portion. The absolute deviation showing the scattering of approximate straight lines approximated by a least squares method is controlled to be 0.08 or less.

### BACKGROUND OF THE INVENTION

1. Field of the Invention

The present invention relates to an electrophotographic toner.

2. Description of the Related Art

Hitherto, image forming apparatus utilizing an electrophotographic method, an electrostatic printing method or the like have been used generally for copying machines, printers and facsimile machines. For example, images are formed in an electrophotographic image forming apparatus, by using a light sensitive body formed with a light sensitive layer containing a photoconductive material as an image carrier on the surface forming electrostatic latent images in accordance with image information by way of various image preparing processes on the light sensitive body, developing the electrostatic latent images into visible images by a developer containing a toner supplied from a developing device, transferring the visible images onto a recording material such as paper and then heating and pressurizing the images by a developing roller to fix the images to the recording material, thereby forming images on the recording paper.

In the image forming apparatus as described above, a toner is used for visualizing electrostatic latent images formed on the image carrier. As a dry developing method of using the toner, a developing method using triboelectrical charging such as a powder craft method, a cascade method and a magnetic brush method are generally used. Among all, a magnetic brush method has been utilized widely since control for the developing procedure is easy and recorded images of high picture quality can be obtained. The magnetic brush method includes a one-component developing method of conducting development by forming a magnetic brush only with a toner containing a magnetic material and a two-component developing method of conducting development by forming a magnetic brush with a two-component developer containing a toner and magnetic particles referred to as a carrier, in which the toner provided with predetermined charges on the magnetic brush is transferred and deposited to electrostatic latent images on the light sensitive body by a coulomb force to conduct development in any of the methods. The toner comprises a colorant dispersed in a binder resin. For the binder resin, various kinds of synthetic resins having an appropriate electroscopic property and a binding property such as styrenic resins or polyester resins are used. As the colorant, carbon blacks, organic colorants, inorganic colorants, etc. are used.

In the developing method by triboelectric charging, for forming images of a substantially constant picture quality for a long time and stably without degradation of images, it is required for the toner that an appropriate charged amount is reached soon after the supply to a developing device, excess charges are not accumulated even when frictional stirring is continued and the charged amount less fluctuates upon outputting images continuously for a long time. Further, it is required for the toner that the chargeability of the toner is not degraded in various circumstances, particularly, in a circumstance of high humidity and that it shows a staple chargeability for a long time.

For obtaining a toner with less aging chance for the chargeability and having stable chargeability, it has been generally conducted to add a toner with a charge controller such as a metal-containing azo dye, a salicylic metal complex, a quaternary ammonium salt, and the like. However, since such charge controllers have no sufficient dispersibility in binder resins, when image formation such as copying is conducted continuously for a long time, fluctuation of the chargeability becomes remarkable, thus sometimes resulting in images of scattered picture quality.

In view of the problems in the prior art, various proposals have been made so far for improving the dispersibility of the charge controller in the binder resin and the stability of the chargeability of the toner.

Those proposals include, for example, a developer for use in development of electrostatic latent images containing a toner at least comprising a binder resin and a metal complex compound containing chromium atoms (charge controller) which exhibits 0.3 or less of an absolute deviation for the error relative to an approximate straight line showing the dispersed state of chromium atoms and carbon atoms determined based on the light emission spectrum for chromium atoms and carbon atoms in the developer obtained by introducing the developer in atmospheric pressure microwave induction plasmas, thereby causing the chromium atoms and the carbon atoms to excite and emit light and measuring the light emission intensity with time (for example, referred to JP-A-2001-13719).

Further, the proposals include a toner for use in electrostatic latent image containing toner particles at least comprising a binder resin, a metal complex compound (charge controller) and a colorant, and external additives wherein the number average grain size and the volume average grain size of the toner have a relation of: volume average grain size/number average grain size ≦1.2, the charged amount A of a toner particle and the charged amount B of a toner have a relation of: B/A ≦1.2, and a light emission voltage X of the carbon atoms derived from the binder resin and a light emission voltage Y of the element derived from the metal complex compound of the toner particle has a relation that the absolute deviation of each of elements upon linear regression to a straight line passing the origin for X and Y is less than 0.08, and the total for X derived from the particles is 5% or less relative to the total for X derived from other particles present on a straight line: Y=0 (refer for example to JP-A-2002-189309).

The prior arts described above intend to improve the dispersibility of the charge controller in the binder resin and obtain a toner of excellent charging stability, by exciting the toner containing the metal complex compound as the charge controller with plasmas, causing the carbon atoms derived from the toner and the atoms derived from the metal complex compound to emit light and controlling such that the light emission intensity of each of them has a relation of a linear function and the absolute deviation of each of the light emission intensity is less than a predetermined value. According to the prior arts described above, while the dispersibility of the charge controller in the binder resin is improved and the charging stability of the toner is improved in a case of continues image formation during long time, the charging stability of the toner under high temperature and high humidity can not be improved.

Further, the charging stability of the toner also undergoes the effect of the acid value of the binder resin. In a case where the acid value of the binder resin is excessively high, the fluidity of the toner fluctuates by the increase or decrease of the moisture content on the surface of the toner particle along with change of the humidity, the chargeability is degraded greatly, and the toner can no more be charged sufficiently. As a result, it tends to cause a phenomenon of the background fogging where the toner is deposited to a portion other than the electrostatic latent images (non-image area) in the developing area on the image carrier. The background fogging deteriorates the picture quality of the images and also increases the consumption amount of the toner. Further, it also results in a disadvantage that the toner scatters in the image forming apparatus to contaminate inside the apparatus. Further, in a case where the acid value of the binder resin is excessively low, the chargeability of the toner becomes insufficient to deteriorate the dispersibility of the charge controller, the colorant, etc. in the binder resin, so that the toner chargeability becomes instable in a case of continuously forming images during long time to sometimes result in various image defects. Further, this makes it difficult to disperse a releasing agent added internally to the toner together with the charge controller, the colorant, etc. into the binder resin for preventing fusion between each of toners and fusion of the toner to the developing roller, and the releasing agents exude to the toner surface unnecessarily to contaminate the image carrier. In addition, it causes fusion of the toner to the charging member in the one-component developing system or fusion to the carrier surface of the toner in the two-component developing system. This tends to cause charging failure of the toner and, thus, background fogging, particularly, during long time use. Even when the acid value of the birder resin is within an appropriate range, the charging stability of the toner under high temperature and high humidity can not be improved by merely using the method of the prior arts described above.

On the other hand, use of a zirconium compound having salicylic acid and derivative thereof as a ligand and zirconium as a center atom for the charge controller of the toner for use in electrostatic image development is known (for example, in the pamphlet of WO99/12941). However, the pamphlet of WO99/12941 neither describes nor suggests definition of the light emission voltage of carbon atoms and zirconium compound to a predetermined relation upon introduction into helium atmospheric pressure microwave induction plasmas and excitation and light emission of the carbon atoms and the atoms derived from the salicylic metal complex, as well as any particular effect obtained therefrom.

### SUMMARY OF THE INVENTION

An object of the invention is to provide an electrophotographic toner having stable chargeability also in a continuous formation of images for a long time, capable of forming images having high image density with scarce occurrence of background fogging and, further, with no deterioration of the chargeability, not causing background fogging, and contamination inside the image forming apparatus due to scattering therein also under high temperature and high humidity.

The invention provides an electrophotographic toner comprising a binder resin, a colorant, a releasing agent, and a charge controller, in which an acid value of the binder resin is 5 to 15 mgKOH/g and the charge controller is a salicylic metal complex, wherein an absolute deviation exhibiting scattering of an approximate straight line exhibits 0.08 or less which approximate straight line is obtained by approximation based on a least squares method for the distribution of a third root of a light emission voltage of metal atoms derived from the salicylic metal complex relative to a third root of a light emission voltage of carbon atoms obtained on every toner particle upon introducing the toner into helium atmospheric pressure microwave induction plasmas and causing the carbon atoms and the atoms derived from the salicylic metal complex to excite and emit light.

Further, in the invention, it is preferable that the center atom of the salicylic metal complex is zirconium.

Further, in the invention, it is preferable that a content of the charge controller is 0.5 to 3 parts by weight per 100 parts by weight of the binder resin.

Further, in the invention, it is preferable that the binder resin is a polyester resin.

Further, in the invention it is preferable that the electrophotographic toner is used as a full color toner having a chromatic color.

Further, in the invention, it is preferable that a content of the colorant is 1 to 10 parts by weight per 150 parts by weight of the binder resin.

Further, in the invention, it is preferable that a content of the releasing agent is 1 to 10 parts by weight per 100 parts by weight of the binder resin.

According to the invention, an electrophotographic toner comprising a binder resin with an acid value of 5 to 15 mgKOH/g, a colorant, a releasing agent, and a salicylic metal complex as a charge controller can be obtained which has extremely less fluctuation of a chargeability and has no deterioration of the chargeability in any of the case of continuous formation of images during Long time and formation of images under high temperature and high humidity, in a case where a predetermined relation exists between a light emission voltage of the carbon atoms and a light emission voltage of the salicylic metal complex when the toner is caused to excite and emit light in helium atmospheric microwave induction plasmas.

Accordingly, the electrophotographic toner of the invention can stably form images having a predetermined high picture quality and a high image density without causing development giving undesired effects or the picture quality such as background fogging and with no contamination inside the image forming apparatus during normal image formation, as well as during continuous format on of images for a long time and formation of images under high temperature and high humidity.

Further according to the invention, among the salicylic metal complexes, those having zirconium as the center atom are preferred. The dispersability of the salicylic metal complex in the binder resin is further improved and the chargeability of the obtained electrophotographic toner is further stabilized by using a salicylic metal complex having zirconium as the center atom and controlling the relation between the light emission voltages as defined in the invention.

Further, according to the invention, an electrophotographic toner particularly excellent for the charging stability during continuous image formation in a long time and image formation under high temperature and high humidity can be obtained by using from 0.5 to 3 parts by weight of the charge controller per 100 parts by weight of the birder resin.

Further, according to the invention, images of a high picture quality, can be formed stably without causing background fogging also in the use of an initial state, and not deteriorating the picture quality ever in continuous formation of images for a long time, by using a polyester resin as the binder resin. In addition, in a case of use as a color toner for full color use, preferred full color mages of high chroma and secondary color reproducibility can be formed.

Further, according to the invention, the electrophotographic toner is particularly suitable to use as a color toner for use in full color.

### BRIEF DESCRIPTION OF THE DRAWINGS

Other and further objects, features, and advantages of the invention will be more explicit from the following detailed description taken with reference to the drawings wherein:

FIG. 1 is a side elevational view schematically showing the constitution of a micro-particle measuring apparatus used for measuring the light emission intensity of atoms;

FIG. 2 is a graph for a synchronous distribution showing a relation between a third root voltage for carbon atoms and a third root voltage for zirconium atoms in an electrophotographic toner of Example

FIG. 3 is a graph for a synchronous distribution showing a relation between a third root voltage for carbon atoms and a third root voltage for zirconium atoms in an electrophotographic toner of Comparative Example 1;

FIG. 4 is a diagram showing an absolute deviation of zirconium atoms and scattering thereof when an approximate straight line is determined in Example 1; and

FIG. 5 is a diagram showing an absolute deviation of zirconium atoms and scattering thereof when an approximate straight line is determined in Comparative Example 1.

### DETAILED DESCRIPTION

Now referring to the drawings, preferred embodiments of the invention are described below.

The electrophotographic toner according to the invention contains a binder resin, a salicylic metal complex, a colorant, and a releasing agent, and an absolute deviation exhibiting scattering of an approximate straight line exhibits 0.08 or less which absolute deviation is obtained by approximation based on a least square method for a distribution of a third root of a light emission voltage of metal atoms relative to a third root of a light emission voltage of carbon atoms obtained on every toner particle upon introducing the toner into helium atmospheric pressure microwave induction plasmas and causing the carbon atoms derived from the binder resin and metal atoms derived from the salicylic metal complex to excite and emit light.

That is, the electrophotographic toner according to the invention contains carbon atoms derived from the binder resin and metal atoms derived from the salicylic metal complex used as the charge controller. When such toner particles are introduced into plasmas and the light emission intensity is measured, the dispersed state of the charge controller in the toner particles can be analyzed.

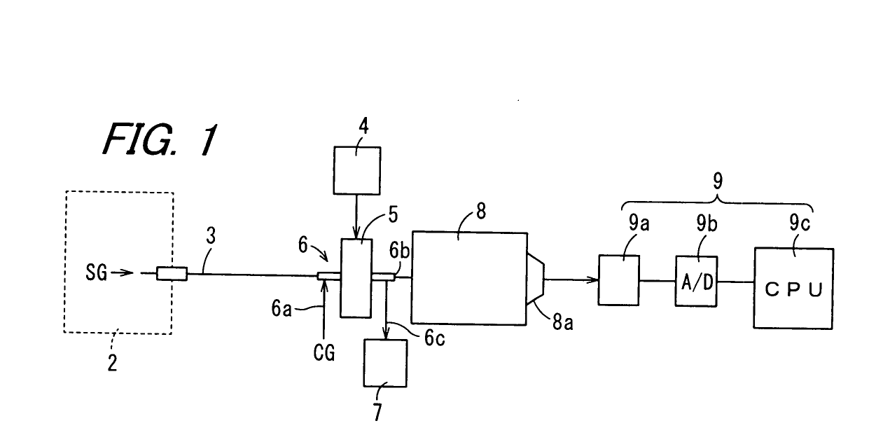

For the measurement of the light emission intensity, a micro-particle measuring apparatus 1 shown in FIG. 1 is used for example. FIG. 1 is a side elevational view schematically showing the constitution of the micro-particle measuring apparatus 1. The micro-particle measuring apparatus 1 comprises a space 2 under a normal pressure or atmospheric pressure as in a normal pressure CVD apparatus, a capillary tube 3 inserted at one end into the space 2 for sampling a sample gas (SG), a microwave source 4, a cavity 5 to which microwaves from the microwave source 4 are introduced, a quartz tubular reactor 6, a discharge means 7, an analysis means 8, and a signal detection portion 9.

A sample gas (SG) containing toner particles is present in the space 2 at the normal pressure or atmospheric pressure.

The tubular reactor 6 is disposed so as to penetrate the cavity 5 and connected at one end thereof with the capillary tube 3, and has a carrier gas introduction portion 6a for introducing a carrier gas (CG) and is provided with a detection window 6b and a gas discharge portion 6c at the other end. Helium is used for the carrier gas (CG).

The discharge means 7 is connected with the gas discharge portion 6c of the tubular reactor 6 and evacuates the inside of the tubular reactor 6 by way of the gas discharge portion 6 into a depressurized state.

The analysis means 8 is disposed toward the detection window 6b and has a detection portion 8a, which qualitatively or quantitatively analyzes micro-particles in the sample gas (SG). A spectral analyzer is used in this embodiment. The detection portion 8a comprises a photomultiplier.

The signal detection portion 9 comprises a pre-amplifier 9a, an A/D converter 9b, and an operation processing circuit 9c using a microprocessor.

In the micro-particle measuring apparatus 1, inside of the tubular reactor 6 is depressurized by the discharge means 7 to such an extent as capable of atomization and/or ionization, plasmas are generated by introducing a helium gas from the carrier gas introduction portion 6a into the tubular reactor 6 and introducing the microwaves from the microwave source 4 respectively, a sample gas (SG) at a normal pressure is introduced from the capillary tube 3, and light emission spectrum of ions generated in the tubular reactor 6 by fine particles (toner) contained in the sample gas (SG) is inline-analyzed by the analysis means 8 thereby capable of conducting qualitative or quantitative analysis for the particles (toner). The internal pressure of the micro-particle measuring apparatus 1 during measurement is 750 torr (about 9.999×10⁴ Pa) and the amount of the helium gas introduced is 450 ml/min. Other values are automatically set upon measurement.

According to the micro-particle measuring apparatus 1, in a case where a salicylic metal complex, for example, is contained in the toner particles, light emission spectrum for carbon atoms derived from the binder resin and for metal atoms (A) derived from the salicylic metal complex can ce obtained. Accordingly, the amount of the binder resin and the salicylic metal complex in the toner particles can be determined. In a case where the compound containing the metal atoms (A) is not present in the toner particle but the toner particle and the metal atom (A) are present separately in the sample gas, since the carbon atoms and the metal atoms (A) emit light separately, they form a synchronous light emission spectrum with a deviation relative to the time axis in a case where the salicylic metal complex is contained In the toner particle, since the carbon atoms and the metal atoms (A) emit light simultaneously, they form synchronous light emission spectrum with no deviation relative to the time axis. The micro-particle measuring apparatus 1 detects a signal in proportion with the number of atoms (mass) of the element and, since the third root for the number of atoms is in proportion with the grain size and, further, since the third root voltage is at a level in proportion with the grain size, the number of atoms for the carbon atom and the number of atoms for the metal atoms (A) per one toner particle can be determined as the third root voltage in view of the intensity of the synchronous light emission spectrum.

Then, a great amount of samples are analyzed at once and, in a distribution chart expressing a third root voltage of the synchronous light emission spectrum for carbon atoms or X-axis, and a third root voltage of the synchronous light emission spectrum for metal atoms (A) on Y-axis, a straight line passing the origin calculated based on the least squares method can be drawn, the straight line is an approximate straight line representing the incorporated state or the compound containing the metal atom (A) in the toner particle.

The error relative to the approximate straight line is determined as: error value x=d/H. Herein, d represents the length of a perpendicular dropped from the data point to the approximate straight line, and H represents the length of a perpendicular from the intersection between the approximate straight line and the perpendicular to the X-axis. The value of the absolute deviation for the error is determined as: 1/n(Σ|x-x′|) Herein, n represents the number of error data and x′ represents an average value for error data. In a case where the dispersion of the salicylic metal complex is insufficient and the difference for the amount of the salicylic metal complex contained on every toner particle is large, scattering of the light emission intensity for the metal atoms (A) derived from the salicylic metal complex increases and the absolute deviation also increases. In a case where the absolute deviation is larger than 0.08, the dispersed state of the salicylic metal complex in the toner particle is worsened, and the toner charging stability is lowered in the continuous formation of images for a long time and images having substantially constant picture quality can not be obtained stably. Further, under high temperature and high humidity, the toner causes charging failure to result in the background fogging and the like. It is more preferred that the absolute derivation value is smaller than 0.08.

The micro-particle measuring apparatus per se is known which is described, for example, in JP-B-7-54294. Further, commercial products are also known and include, for example, the particle analyzer PT-1000 (trade name of products, manufactured by Yokogawa Electric Corp.).

Further, a software for determining the absolute deviation value defined in the invention based on the measured values by the micro-particle measuring apparatus 1 is commercially available. Accordingly, in the invention, the absolute deviation value may be determined by calculation based on the measured values, or the absolute deviation value may also be determined by using the software commercially available. Specific examples of the commercially available software include, for example, Toner Analysis Soft version 2.00 (trade name of products manufactured by Yokogawa Electric Corp.).

Ingredients contained in the electrophotographic toner according to the invention are to be described.

(a) Binder Resin

The binder resin has an acid value of 5 to 15 mgKOH/g. In a case where the acid value is less than 5 mgKOH/g, the dispensability of the colorant and the charge controller contained in the toner is insufficient to deteriorate the charging stability of the toner and images having substantially constant picture quality can not be obtained stably. Further, in a case of using the toner according to the invention as a color toner, the dispersibility of the colorant gives an effect on the spectral characteristics of the toner and lowering of the dispersibility of the colorant results in lowering of the chroma and the image density. Further, a releasing agent exudes to the toner surface to contaminate the drum surface resulting in fusion to the charging member in a one-component developing system or fusion to the carrier surface in a two-component developing system. As a result, charging failure of the toner tends to occur during long time use to result in the background fogging or the like. On the other hand, in a case where it exceeds 15 mgKOH/g, the hygroscopicity of the toner increases so that the water content of the toner even under a normal humidity increases, and the charging amount is lowered tending to cause the background fogging or the like. The acid value was measured by the method according to JIS K0070.

The binder resin is not particularly limited and those customarily used in this field can be used so long as the acid value is from 5 to 15 mgKOH/g and, among all, a polyester resin is preferred.

Since the polyester resin has relatively higher chargeability compared with other binder resins and, particularly, can decrease the occurrence of the background fogging in the initial stage of use as the toner, it has an advantage capable of obtaining high image quality from the initial stage of use. Further, since a high chargeability can be maintained by the combined use with the charge controller, images at high picture quality with no image deterioration can be obtained continuously and stably also in continuous formation of images during long time. Further, since the polyester resin has excellent transparency, it gives no undesired effects on the chroma and the secondary color reproducibility even in a case of using the toner of the invention as the color toner.

While those used customarily in this field can be used as the polyester resin, polyester resins synthesized, for example, from a polyhydric alcohol ingredient and a polybasic carboxylic acid ingredient are preferred.

Known polyhydric alcohol ingredient can be used and includes, for example, dihydric alcohols, tri- or higher polyhydric alcohols. The dihydric alcohols include, for example, ethylene glycol, 1,2-propylene glycol, 1,3-propylene glycol, 1,4-butanediol, 2,3-butanediol, diethylene glycol, triethylene glycol, 1,5-pentanediol, 1,6-hexanediol, neopentylene glycol, 1,4-cyclohexane dimethanol, dipropylene glycol, polyethylene glycol, polypropylene glycol, bisphenol A, hydrogenated bisphenol A, alkylene oxide adduct of bisphenol A such as polyoxyethylanated bisphenol A and polypropylanated bisphenol A. Tri- or higher polyhydric alcohols are used for making the polyester resin non-linear to such an extent as not forming tetrahydrofuran insoluble components, for instance. The tri- or higher polyhydric alcohol includes, for example, glycerine, sorbitol, 1,2,3,6-hexanetetraol, 1,4-sorbitan, pentaerythritol, 1,2,4-butanetriol, 1,2,5-pentanetriol, 2-methylpropanetriol, 2-methyl-1,2,4-butanetriol, tri-methylolethane, trimethylol propane, and 1,3,5-trihydroxymethyl benzene. The polyhydric alcohol ingredients can be used each alone or two or more of them can be used together.

Known polyhydric carboxylic acid ingredient can be used and include, for example, dibasic carboxylic acids such as maleic acid, fumaric acid, mesaconic acid, citraconic acid, itaconic acid, glutaconic acid, phthalic acid, terephthalic acid, isophthalic acid, cyclohexane dicarboxylic acid, malonic acid, succinic acid, adipic acid, sebasic acid, glutalic acid, an alkyl succinic acid such as n-octyl succinic acid and n-dodecenyl succinic acid, acid anhydrides thereof, and alkyl esters thereof. The polybasic carboxylic acid ingredients can be used each alone or two or more of them can be used together.

(b) Charge Controller

As the charge controller, a metal complex of salicylic acid is used. The metal complex of salicylic acid is stable as a compound and has an advantage capable of providing the toner with a satisfactory charging stability. Further, since it is monochromatic or colorless and gives less effect on the color of images formed by the toner, it is particularly suitable for a case of using the toner according to the invention as a color toner.

Among the metal complexes of the salicylic acid, a zirconium salicylate complex in which salicylic acid is coordinated to zirconium as a center metal for toe complex is Preferred. The zirconium salicylate complex is excellent in environmental safety, the dispersibility in the binder resin and the stability as the compound and can provide the toner with an excellent charging stability, as well as can prevent charging at opposite polarity to the toner.

Known zirconium salicylate complexes can be used and Include, for example, a zirconium salicylate complex. (1) represented by the following general formula (1) 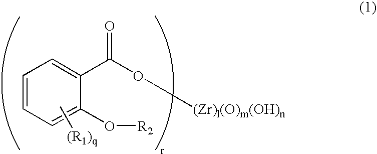
[(where R₁, which may be identical or different, each represents an alkyl group, an alkenyl group, an alkoxy group, an aryl group which may have a substituent, an aryloxy group which may have a substituent, an aralkyl group which may have a substituent, an aralkyloxy group which may have a substituent, a halogen atom, a hydrogen atom, a hydroxyl group, an amino group which may have a substituent, a carboxyl group, a nitro group, a nitroso group, a sulfonyl group, or a cyano group, R₂ represents a hydrogen atom or an alkyl group, 1 represents an integer of 1 to 20, m represents 0 or an integer of 1 to 20, n represents 0 or an integer of 1 to 20, q represents 0 or an integer of 1 to 4, and r represents an integer of 1 to 20, respectively.]

The zirconium salicylate complex (1) can be prepared by reacting salicylic acid or a derivative thereof, and a zirconium compound. Salicylic acid or the salt thereof includes, for example, salicylic acid, 3,5-di-t-butyl salicylic acid, methyl ether of 3,5-di-t-butyl salicylic acid, methyl ether of 3-t-butyl-5-methylbutyl salicylic acid, 3,5-dichloro salicylic acid, 5-methoxy salicylic acid, and 3,5-di-isopropyl salicylic acid. Further, salts of them can also be used. The zirconium compound includes, for example, zirconium halide compounds such as ZrCl₄, ZrF₄, ZrBr₄, and ZrI₄, inorganic zirconium compounds such as Zr(OR)₄ (where R represents an alkyl group or alkenyl group), and Zr(SO₄)₂, inorganic acid zirconium compounds such as ZrOCl₂, ZrOCl₂.8H₂O, ZrO(NO₃)₂, ZrO(ClO₄)₂, H₂ZrO(SO₄)₂, ZrO(SO₄) Na₂SO₄, and ZrO(HPO₄)₂, and organic acid zirconium compounds such as ZrO(CO₃), (NH₄)₂ZrO(CO₃)₂, (NH₄)₂ZrO(C₂H₃O₂)₂, and ZrO(C₁₈H₃₅O₂)₂. Zr(OR)₄ is zirconium alkoxide, zirconium alkenyloxide, etc., and includes, for example, zirconium isopropoxide, zirconium butoxide, etc.

The reaction between salicylic acid or the derivative thereof, and the zirconium compound is conducted, preferably, in water or in an appropriate organic solvent such as toluene at a temperature of about 50° C. In a case of conducting the reaction in the organic solvent, reaction can also be conducted under reflux.

By applying pH control, condensation, etc. to the reaction mixture, a zirconium salicylate complex (1) is precipitated in the reaction mixture. The zirconium salicylate complex (1) can be easily isolated and purified from the reaction mixture by usual separation and purification means, for example, filtration, water washing and drying.

The zirconium salicylate complex (1) is a known compound and described, for example, in International Patent Publication WO39/12941.

The salicylic metal complexes can be used each alone or two or more of them can be used together.

While the amount of the salicylic metal complex used in the electrophotographic toner according to the invention is not particularly limited, it is, preferably, from 0.5 to 3 parts by weight; per 100 parts by weight of a binder resin. In a case where it is less than 0.5 parts by weight, sufficient charging stability cannot sometimes be provided to the toner. On the other hard, in a case where it exceeds 3 parts by weight, dispersion in the binder resin becomes insufficient making the charging stability insufficient during long time use and images having a substantially constant high picture quality can not possibly be obtained stably further, since the amount of a charge controller present on the toner surface increases, this may possibly cause charging failure at a high humidity tending to cause background fogging, etc., further, in a case of using the toner according to the invention for color use, when the amount of the charge controller present on the toner surface is large, transparency of the toner and, thus, chroma and color formation, for example, of secondary colors and tertiary colors are deteriorated.

Together with the salicylic metal complex, one or more of known negatively charging charge controllers can be used within a range not deteriorating the preferred characteristics of the electrophotographic toner according to the invention.

(c) Colorant

As the colorant, those customarily used in this field can be used and they include, for example, colorants for yellow toner, colorants for magenta toner, colorants for cyan toner, and colorants for black toner.

Known colorants for yellow toner can be used and they include, for example, inorganic pigments such as azo pigments, yellow iron oxide, and yellow orchre, for example, C. I. pigment yellow 1, C. I. pigment yellow 5, C. I. pigment yellow 12, C. I. pigment yellow 15, and C. I. pigment yellow 17, nitro dyes such as acid yellow 1, and oil soluble dyes such as solvent yellow 2, C. I. solvent yellow 6, C. I. solvent yellow 14, C. I. solvent yellow 15, C. I. solvent yellow 19, and C. I. solvent yellow 21, classified by the color index. Among them, benzidine type azo pigments such as C. I. pigment yellow 17 are preferred in view of tint or the like.

Known colorants can be used also for the colorants for magenta toner and they include, for example, C. I. pigment red 49, C. I. pigment red 57, C. I. pigment red 81, C. I. pigment red 122, C. I. solvent red 19, C. I. solvent red 49, C. I. solvent red 52, basic red 10, and C. I. dispersed red 15 classified by the color index. Among them, quinacridone type pigments such as C. I. pigment red 122 etc., are preferred in view of tint or the like.

Known colorants can be used also for the colorants for cyan toner and they include, for example, C. I. pigment blue 15, C. I. pigment blue 16, C. I. solvent blue 55, C. I. solvent blue 70, C. I. direct blue 25, and C. I. direct blue 86, classified by the color index. Among them, copper phthalocyanines such as C. I. pigment blue 15, etc., are preferred in view of tint.

Known colorants can be used also for the colorants for black toner and they include, for example, carbon black such is channel black, roller black, disk black, gas furnace black, oil furnace black, thermal black, and acetylene black. From the various kinds of carbon blacks, an appropriate carbon black may be properly selected in accordance with the designed characteristics of the toner to be obtained.

The colorants can be used each alone or two or more of them can be used together. Further, two or more kinds of them or an identical color system can be used, or two or more kinds of them of different color systems may be used.

While the amount of the colorant co be used in the electrophotographic toner according to the invention is not particularly limited, it is, preferably, from 1 to 10 parts by weight per 100 parts by weight of the binder resin. By using the colorant in the range described above, images having high image density and of excellent picture quality can be formed without deteriorating various physical properties of the toner.

(d) Releasing Agent

As the releasing agent, waxes customarily used in this field can be used. Specific examples of the wax include, for example, natural waxes derived from animals such as bee wax, whale wax, and shellac wax, those derived from plants such as carnauba wax, wood wax, rice wax, and candelilla wax, those of petroleum derived waxes such as paraffin wax and microcrystalline wax, those of mineral derived waxes such as montan wax and ozokerite, as well as synthesis waxes such as Fisher-Tropsch wax, polyethylene wax, oil and fat syntheses wax (ester, ketone and amide), and hydrogenated wax. The waxes can be used each alone or two or more of them can be used together. While the amount of the wax to be used in the toner for use in electrophotography according to the invention is not particularly limited, it is, preferably, from 1 to 10 parts by weight per 100 carts by weight of the binder resin.

The electrophotographic toner according to the invention having the absolute deviation value described above can be prepared by properly selecting, for example, the kind of the binder resin, the kind and the amount of use of the salicylic metal complex as a charge controller, and the kind and the amount of use of the colorant. Particularly, the toner according to the invention having the absolute deviation value described above can be prepared easily by selecting the kind and the amount of use of the charge controller and using those properly selected from the colorants for use as the color toners as the colorant.

While known methods can be adapted in the preparation of the electrophotographic toner according to the invention, a pulverization method which can disperse the charge controller and other additives relatively easily in the binder resins preferred. By the pulverization method, the toner particles for use in electrophotography according to the invention can be prepared by previously homogeneously mixing the binder resin, the colorant, the charge controller and additives such as a releasing agent by a usual mixer such as a dry blender, Henschel mixer, or a ball mill, uniformly kneading the obtained starting mixture by a usual kneading machine such as a twin-screw extruder or a single screw extruder, cooling to solidify and pulverizing the kneaded product and then classifying the same according to need. In the pulverization method described above, use of an open roll type kneader as a kneading machine is preferred upon melt kneading the starting mixture. In the open roll type kneader, the gap width between two opposed rolls is formed such that it is gradually narrowed from the feeding side to the discharging side of the starting mixture. By the formation of the gap as described above, the compressive force exerting from the roll to the starting mixture is increased from the feeding side to the discharging side. Thus it can provide an effect of improving the dispersibility of the additives of the obtained kneaded product.

While the grain size of the electrophotographic toner according to the invention is not particularly limited, it is, preferably, from 3 μm to 15 μm in average grain size. For improving the picture quality and obtaining images at high picture quality, a small grain size toner with an average grain size of 9 μm or less is preferred and a smaller grain size toner of 5 μm to 8 μm is further preferred.

External additives can be added to the electrophotographic toner according to the invention. The external additives include, for example, a fluidizing agent. The fluidizing agent is used for improving, for example, the transportability of the toner, the stirring property with the carrier in a case of formulating the chargeable toner as a two-component developer. As the fluidizing agent, those customarily used in this field can be used and they include, for example, inorganic fine particles such as an aluminum oxide powder, a titanium oxide powder and a fine silica powder, fine organic particles such as a fine vinylidene fluoride powder, a fine polytetrafluoroethylene powder, fatty acid metal salts, zinc stearate and calcium stearate, as well as those materials applied with a hydrophobic treatment. Among them, fine inorganic particles applied with the hydrophobic treatment are preferred. The fluidizing agents can be used each alone or two or more of them can be used together. Specific examples of using two or more of them together include a combination of one or more of fine inorganic particles put to the hydrophobic treatment and one or more of fine organic particles. While the amount of the fluidizing agent is not particularly limited and it can be selected properly from a wide range, it is, preferably, from 0.1 to 3 parts by weight per 100 parts by weight of the toner particles. The electrophotographic toner according to the invention containing the fluidizing agent is obtained by mixing the toner particles and the fluidizing agent by a usual mixer, depositing the fluidizing agent to the surface of the toner particles and then removing agglomeration products, obstacles, etc. by sieving or the like.

The electrophotographic toner according to the invention can be used as a one-compartment developer or a two-component developer. In a case of seas the one-component developer, for example, a non-magnetic toner, the toner can be supplied to electrostatic latent images on the surface of a light sensitive body by using a blade and a fur brush, and transporting the toner while being deposited on a sleeve by trioboelectrically charging the toner with a developing sleeve.

In a case of use the two-component developer, a carrier is used together with the electrophotographic toner according to the invention. While the carrier is not particularly limited and those customarily used in the field can be used, a resin coated carrier having a resin coating layer on the core of the carrier is preferred.

The core material for the carrier includes, for example, magnetic metals such as iron, nickel, and cobalt, magnetic oxides such as ferrite and magnetite, and glass beads. The shape of the core material is preferably spherical. Further, the grain size of the core material is, preferably, from 10 to 500 μm and, more preferably, 30 to 100 μm.

The coating resin includes, for example, polyethylene, polypropylene, polystyrene, polyacrylonitrile, polyvinyl acetate, polyvinyl butyral, polyvinyl chloride, polyvinyl carbazole, polyvinyl ether, polyvinyl ketone, vinyl chloride—vinyl acetate copolymer, styrene—acrylic acid copolymer, silicone resin containing organosiloxane bonds and modified products thereof, fluoro resin, polyester, polyurethane, polycarbonate, phenol resin, amino resin, melamine resin, and benzoquanimine resin.

The resin may contain a conductive material. The conductive material includes, for example, metal powder, for example, of gold, silver, and copper, and fine inorganic particle, for example, of carbon black, titanium oxide, and zinc oxide.

### EXAMPLE

The invention is to be described specifically with reference to examples, comparative examples, and test examples in which “part” means “part by weight” hereinafter.

### Examples 1 to 2 and Comparative Examples 1 to 4

[Preparation of Toner]

To 100 parts of polyester resins (binder resin) having acid values shown in Table 1, were pre-mixed 6 parts of a quinacridone pigment (C. I. pigment red 122, colorant), 3 parts of a polypropylene wax, and a zirconium salicylate complex (charge controller) each in the blending amount shown in Table 1 by a Henschel mixer to prepare starting mixtures. A zirconium salicylate complex prepared in accordance with Preparation Example 1 in WO99/12941 were used.

The stirring mixtures were melt kneaded by melt kneaders shown in Table 1 and the obtained kneaded products were cooled and solidified. The obtained solidified products were coarsely pulverized by a speed mill and further pulverized by an I-type jet mill. Further, fine powder and coarse powder were removed by an elbow jet classifier to prepare magenta toner particles of an average grain size of 6.8 μm.

To 100 parts of the magenta toner particles obtained as described above, were mixed 0.5 parts of hydrophobic colloidal silica of 12 nm average grain size and 1.0 part of titanium oxide of 50 nm average grain size, and a surface treatment was applied to prepare toners of the invention and comparative examples.

Further, toners of the invention and the comparative examples were mixed to a copper-zinc ferrite carrier of 60 μm average grain size such that the toner concentration was 4% by weight, to prepare two-component developers.

[Approximate Straight Line]

A stainless steel mesh was placed on a holder and a membrane filter (trade name of products, manufactured by Whatman Co., 25 mm filter diameter and 4 μm aperture diameter) was further attached to constitute a specimen table, which was mounted to a toner suction apparatus and those sucked by an appropriate amount were used as specimens for measurement. The appropriate amount means such an amount that the atoms detected in a greatest amount by scanning for once was from 500 to 1000 counts. The number of scanning was set as 5 cycles and data excluding those from scanning for the first time were collected and analyzed.

A particle analyzer (trade name of products: PT-1000, manufactured by Yokogawa Electric Corp.) was used for the measurement of light emission intensity in plasmas of carbon atoms derived from the binder resin and zirconium atoms derived from the charge controller in the toner particles. The internal pressure of the particle analyzer was set at 750 torr (about 9.999×10⁴ Pa) and a helium gas was introduced to the particle analyzer in an amount of 450 ml/min and other values were automatically set by the particle analyzer.

“Toner Analysis Soft version 2.00” manufactured by Yokogawa Electric Corp. was used for the data analysis, and a distribution chart of a voltage of carbon atoms and of a voltage of zirconium atoms (X-axis represents the third root voltage for the carbon atoms derived from the binder resin and Y-axis represents the third root voltage for the zirconium atoms derived from the zirconium salicylate complex) was obtained to obtain an approximate straight line. The gradient for the approximate straight line and the absolute deviation relative to the approximate straight line was calculated according to the software described above. Table 1 shows the values for the absolute deviation of the magenta toner particles obtained in the examples and the comparative examples.

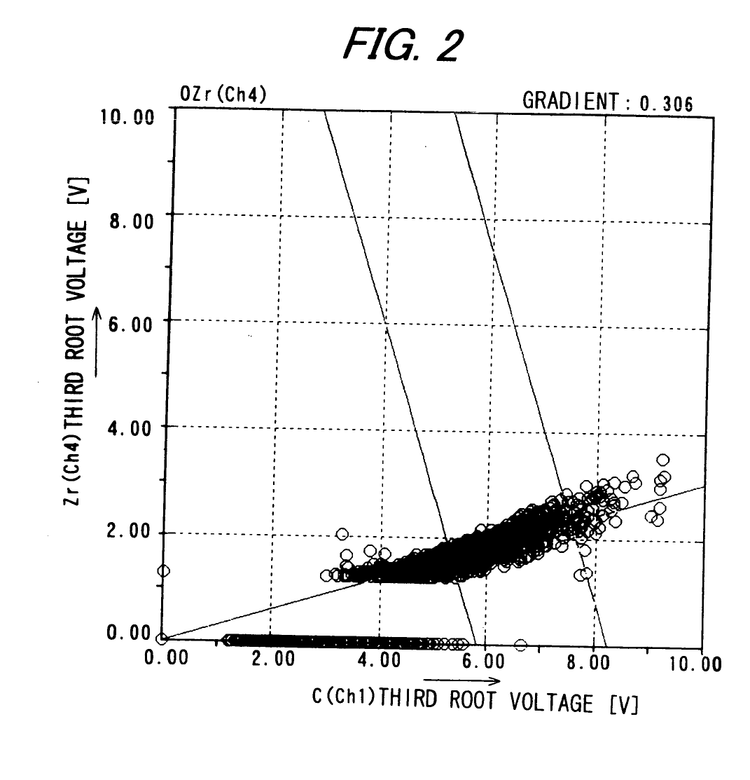

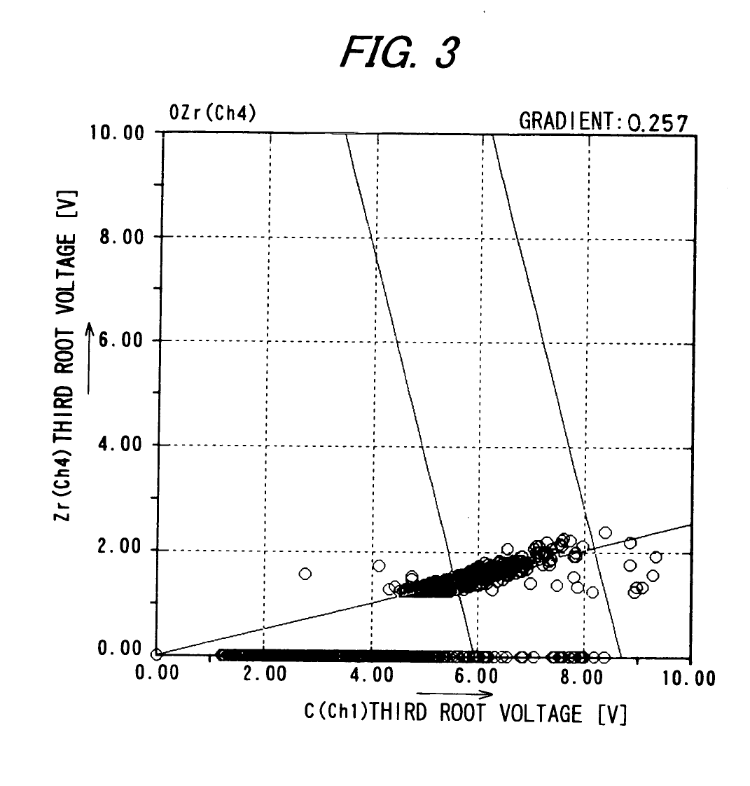

Further, for the magenta toner particles in Example 1 and Comparative Example 1, synchronous distribution charts each showing the relation between the third root voltage of the carbon atoms and the third root voltage of the zirconium atoms are shown, respectively, in FIG. 2 and FIG. 3. In FIG. 2 and FIG. 3, the straight line is an approximate straight line passing the origin calculated according to the least squares method.

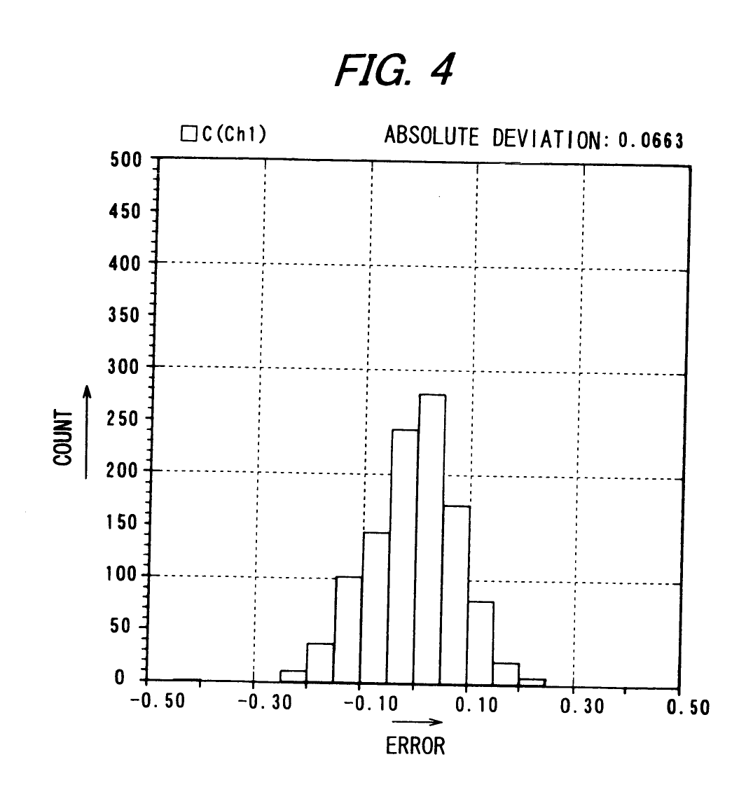

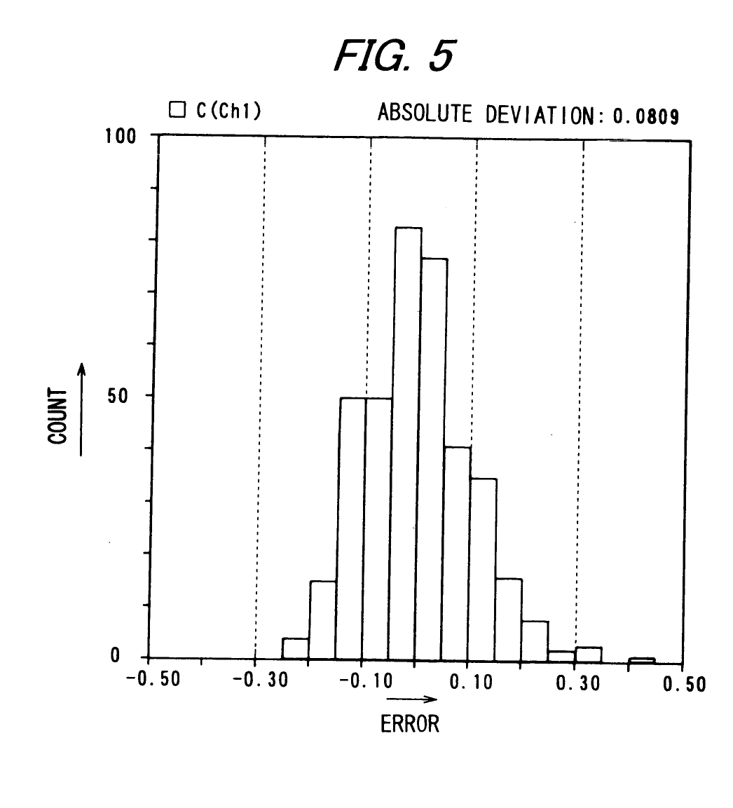

Further, the absolute deviations of the zirconium atoms and scattering thereof when the approximate straight lines was determined for the magenta particles in Example 1 and Comparative Example 1 are shown, respectively, in FIG. 4 and FIG. 5.

TABLE 1

| | | Binder resin | | Charge | | | |
|---|---|---|---|---|---|---|---|
| | | | Acid | controller | | Kneading | Absolute |
| | | Kind | value | (part) | Melt kneader | temperature | deviation |
| Example | 1 | Polyester | 6.5 | 2 | Open roll type | 120 | 0.066 |
| | 2 | Polyester | 12.9 | 2 | Open roll type | 120 | 0.048 |
| | 3 | Polyester | 10.1 | 0.5 | Open roll type | 120 | 0.058 |
| | 4 | Polyester | 10.1 | 3 | Open roll type | 120 | 0.068 |
| | 5 | Polyester | 10.1 | 0.3 | Open roll type | 120 | 0.051 |
| | 6 | Polyester | 10.1 | 3.5 | Open roll type | 120 | 0.075 |
| Comp. | 1 | Polyester | 10.1 | 2 | Twin-screw | 130 | 0.081 |
| Example | | | | | extrusion type | | |
| | 2 | Polyester | 2.5 | 2 | Open roll type | 120 | 0.078 |
| | 3 | Polyester | 2.5 | 2 | Twin-screw | 120 | 0.10 |
| | | | | | extrusion type | | |
| | 4 | Polyester | 18 | 2 | Twin-screw | 120 | 0.051 |
| | | | | | extrusion type | | |

### Test Example 1

For the two-component developers obtained in Examples 1 to 6 and Comparative Examples 1 to 4, occurrence of background fogging and charged amount were evaluated as described below. The results are shown in Table 2 and the result of evaluation are shown in Table 3.

[Evaluation for Background Fogging and Charged Amount]

Two-component developers of Examples 1 to 6 and Comparative Examples 1 to 4 were filled in a commercial copying machine having a two-component full color developing device (trade name of products: ARC150, manufactured by Sharp Corp.) and the background fogging and the charged amount were measured at normal temperature and normal humidity in the initial state and after actual reproduction for 20,000 sheets at 5% printed images. Further, 1 part of the toner left for one day at high temperature and high humidity (35° C./85%) was supplemented to 100 parts of the two-component developer after actual reproduction for 20,000 sheets and the background fogging and the charged amount were measured. The toner was identical with the toner contained in the two-component developer filled initially.

White solid images were printed to A4 sized paper previously measured for the image density by X-Rite 938 (trade name of products X-rite Co.) and the background fogging was measured at given 9 points, the difference with respect to the image density value of A4 sized paper per se, was determined, to calculate average values. They were evaluated as “A” for those of less than 0.015, as “B” for those of 0.015 or more and less than 0.025, as “C” for those of less than 0.035, and as “D” for those of 0.035 or more.

For the charged amount (μC/g), each of the two-component developers sampled from the magnet roller was blown and the charged amount was measured by a suction type small-sized charged amount measuring apparatus (q/m, trade name of products: 210HS-2A, manufactured by Trek Co.). The charged amount was measured for the initial state, after actual reproduction for 20,000 sheets, and after actual reproduction for 20,000 sheets and with toner supplementation, and they were evaluated as “A” for those of less than 5%, as “B” for those of 5 to 10%, as “C” for those of 10 to 20% and as “D” for those of more than 20%, with regard to the coefficient of change after actual reproduction for 20,000 sheets relative to the initial charged amount, and after actual reproduction for 20,000 sheets and with toner supplementation relative to after actual reproduction for 20,000 sheets.

The initial coefficient of change (%) means a percentage for the absolute value of difference between the initial charged amount and the charged amount after actual reproduction for 20,000 sheets relative to the initial changed amount. The coefficient of change after supplementation (%) means a percentage of the absolute value of difference between the charged amount after actual reproduction for 20,000 sheets and the changed amount after actual reproduction for 20,000 sheets and with the charged amount after toner supplementation, relative to the charged amount after actual reproduction for 20000 sheets.

TABLE 2

| | | | | After actual reproduction for 20,000 | | | After actual reproduction for 20,000 | | |
|---|---|---|---|---|---|---|---|---|---|
| | | Initial state | | sheets | | | sheets + toner supplementation | | |
| | | | Charged | | Charged | Coefficient of | | Charged | Coefficient of |
| | | Background | amount | Background | amount | change % at | Background | amount | change % after |
| | | fogging | μC/g | fogging | μC/g | initial state | fogging | μC/g | supplementation |
| Example | 1 | 0.008 | −28.3 | 0.018 | −30.5 | 7.7 | 0.024 | −27.8 | 8.9 |
| | 2 | 0.006 | −35.4 | 0.014 | −36.1 | 2 | 0.021 | −30.3 | 16.1 |
| | 3 | 0.01 | −25.5 | 0.024 | −21.5 | 15.7 | 0.024 | −20.3 | 5.6 |
| | 4 | 0.007 | −31.4 | 0.015 | −33 | 5.1 | 0.021 | −28.5 | 13.6 |
| | 5 | 0.012 | −22.6 | 0.028 | −18.5 | 18 | 0.03 | −18.3 | 1.1 |
| | 6 | 0.006 | −34.4 | 0.017 | −34.2 | 0.5 | 0.026 | −28.1 | 12.7 |
| Comp. | 1 | 0.007 | −31.6 | 0.025 | −26.4 | 22.9 | 0.038 | −21.1 | 15.7 |
| Example | 2 | 0.01 | −22.3 | 0.036 | −18.4 | 17.5 | 0.043 | −16.3 | 11.4 |
| | 3 | 0.009 | −24.1 | 0.033 | −19.1 | 20.7 | 0.051 | −14.4 | 24.6 |
| | 4 | 0.006 | −40.1 | 0.01 | −41.5 | 0.4 | 0.037 | −22.5 | 45.8 |

TABLE 3

| | | Initial state | After actual reproduction for | | After actual reproduction for 20,000 | | |
|---|---|---|---|---|---|---|---|
| | | Evaluation | 20,000 sheets | | sheets + toner supplementation | | |
| | | for | Evaluation for | | Evaluation for | | |
| | | background | background | Evaluation for | background | Evaluation for | Overall |
| | | fogging | fogging | chargeability | fogging | chargeability | estimation |
| Example | 1 | A | B | B | B | B | Good |
| | 2 | A | A | A | B | C | Good |
| | 3 | A | B | C | B | B | Good |
| | 4 | A | B | B | B | C | Good |
| | 5 | A | C | C | C | A | Good |
| | 6 | A | B | A | C | C | Good |
| Comp. | 1 | A | C | D | D | C | Bad |
| Example | 2 | A | D | C | D | C | Bad |
| | 3 | A | C | D | D | D | Bad |
| | 4 | A | A | A | D | D | Bad |

It is apparent from Table 2 and Table 3 that since the dispersibility of the zirconium salicylate complex as the charge controller was satisfactory, the electrophotographic toners of Examples 1 to 6 according to the invention were stable in the charged amount also during long time use and showed no occurrence of background fogging. Further, it is apparent that since the electrophotographic toners in Examples 1 to 6 of the invention suffered from no significant effect of humidity for the chargeability even when left at high temperature and high humidity, they were charged sufficiently even supplemented after being left at high temperature and high humidity to the image forming apparatus and caused no background fogging.

On the other hand, in the toners of Comparative Examples 1 to 3, since the dispersibility of the charge controller was poor, they lacked in the stability of the chargeability during long time use, the charged amount lowered after actual reproduction for 20,000 sheets compared with that in the initial state and the background fogging was remarkable. Further, while it can be said that the dispersion of the charge controller of Comparative Example 2 was at a satisfactory level, since the releasing agent exuded to the toner surface of the low acid value of the binder resin, it contaminated the carrier during long time use to also lower the charged amount thus resulted in the background fogging. Also in the toner of Comparative Example 4, while the dispersibility of the charge controller was satisfactory, since the acid value of the binder resin was high, the dependence on the circumstance was high to deteriorate the chargeability at high humidity and occurrence of the background fogging was remarkable. Further, also for toners of Comparative Examples 1 to 3, the charged amount was lowered to result in the background fogging when left at high humidity, although being different in degree.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An electrophotographic toner comprising:
a binder resin;
a colorant;
a releasing agent; and
a charge controller,
in which an acid value of the bonder resin is 5 to 15 mgKOH/g and the charge controller is a salicylic metal complex,
wherein an absolute deviation exciting scattering of an approximate straight line exhibits 0.08 or less which approximate straight line is obtained by approximation based on a least squares method for the distribution of a third root light emission voltage of metal atoms derived from salicylic metal complex relative to a third root of a light emission voltage of carbon atoms obtained every toner particle upon introducing the toner into helium atmospheric pressure microwave induction plasmas and causing the carbon atoms and the atoms derived from the salicylic metal complex to excite and emit light.

2. The electrophotographic tone: of claim 1, wherein the center atom of the salicylic metal complex is zirconium.

3. The electrophotographic toner of claim 1, wherein a content of the charge controller is 0.5 to 3 parts by weight per 100 parts by weight of the binder resin.

4. The electrophotographic toner of claim 1, wherein the binder resin is a polyester resin.

5. The electrophotographic toner of claim 1, wherein the electrophotographic toner is used as a full color toner having a chromatic color.

6. The electrophotographic toner of claim 1, wherein a content of the colorant is 1 to 10 parts by weight per 100 parts by weight of the binder resin.

7. The electrophotographic toner of claim 1, wherein a content of the releasing agent is 1 to 10 parts by weight per 100 parts by weight of the binder resin.
